(19) United States
(12) Patent Application Publication
(10) Pub. No.: US 2005/0060370 A1
(43) Pub. Date: Mar. 17, 2005

(54) Version based content distribution and synchronization system and method

(75) Inventors: Xin Xue, San Jose, CA (US); Naoyuki Sato, Campbell, CA (US); Quan Vu, Milpitas, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 10/666,888

(22) Filed: Sep. 17, 2003

(51) Int. Cl. G06F 15/16; G06F 17/30; G06F 12/00

(52) U.S. Cl. 709/204; 707/203

(57) ABSTRACT

A version based content distribution and synchronization system configured for content distribution from a syndicator to a subscriber is disclosed. The preferred system comprises version based content, a syndicator, subscriber content, and a subscriber. Preferably, the content comprises a version number and the subscriber content comprises a subscriber content version number. The version based content preferably comprises digital media. The version based content is preferably stored and organized on the syndicator in a tree like structure. The syndicator preferably compares the version number of the version based content with the subscriber content version number of the subscriber content. If the version number is greater than the subscriber content version number, the version based content is transferred from the syndicator to the subscriber. Preferably, the version based content is distributed and synchronized via an internet protocol method.

### FIELD OF THE INVENTION

The present invention relates to the field of content distribution and synchronization systems and methods. More particularly, this invention relates to methods and systems that distribute and synchronize version based content from a syndicator to a subscriber.

### BACKGROUND OF THE INVENTION

The advent of Personal Digital Assistants (PDAs) and other electronic hand held devices has allowed easy storage, manipulation, and use of electronic data on the go. Current PDAs are designed to work in tandem with a personal computer (or other electronic device). In addition, the data stored in both the PDA and the personal computer (PC) must also work in tandem. For example, appointments entered into the personal computer must be transferred to the PDA; addresses and phone numbers entered into the PDA must be uploaded to the personal computer. Further, PDA data must be backed up onto the PC to prevent data loss (in case of battery power failure, for example). In short, current PDAs and PCs allow for the storage, manipulation, and use of electronic data by communicating (or synchronizing). This is typically done through a serial or USB port on the PDA. Other current means of synchronizing include PDA cradles, infrared (or other wireless) communications ports, or telephone modems.

In such configurations, the data which is synchronized between current PDAs and other electronic devices is a matter of rudimentary data transfer from one device to another. This creates the possibility of loss of data caused by data overriding. Further, current synchronization methods are inefficient and ineffective in that every data item to be distributed or synchronized must be compared during the synchronization update, placing a great deal of command overhead on both the PC and the PDA.

### SUMMARY OF THE INVENTION

A version based content distribution system is disclosed. This version based content distribution system is designed for version based content distribution from a syndicator to a subscriber. The system comprises version based content, a syndicator, subscriber content, and a subscriber. The version based content comprises a version number. Similarly, the subscriber content comprises a subscriber content version number.

The syndicator is configured to distribute the version based content and the subscriber is configured to store the version based content as well as the subscriber content. Preferably, the syndicator comprises a server and utilizes the server as the controller, distributor, and synchronizer for all the version based content and subscribers. The version based content is preferably distributed by a syndicator's web server to subscriber clients.

The subscriber is configured to compare the version based content's version number with the subscriber content version number. Further, the subscriber is configured to receive the content from the syndicator if the version number is larger than the subscriber content version number. The preferred subscriber is further configured to display the subscriber content and comprises a personal digital assistant. In alternate embodiments, the subscriber comprises a hand held electronic device. In yet other embodiments, the subscriber comprises a personal computer.

The syndicator of the version based content distribution system disclosed above further comprises a data synchronization scheme in alternate embodiments. The data synchronization scheme is configured to compare the version based content's version number with the subscriber content version number and to transfer the version based content to the subscriber based on a predetermined transfer method. In the various embodiments, the predetermined transfer methods include, but are not limited to, application driven, isochronous, or syndicator to subscriber one-way synchronization data transfer methods.

In the preferred version based content distribution system, the subscriber is configured to communicate with the syndicator via an internet protocol method. Further, the subscriber is configured to receive content based on preferences set by a user of the subscriber. The syndicator alternately is further configured to store the content.

The version based content is preferably organized on the syndicator in a tree like structure. Specifically, the tree like structure comprises one or more channels. For example, the channels may be named “Music,” “Movies,” or “Games.” Each of the one or more channels comprise one or more subchannels. Examples of the “Music” subchannel include subchannels such as “Blues,” “Electronica,” “Reggae.” Further, the “Movies” subchannel may include “Action,” “Mystery,” or “Musicals” subchannels. The “Games” subchannel may include “Role Playing,” “Simulators,” or “Action,” for example. Further, each of the one or more subchannels comprise one or more categories. The “Electronica” category includes “Drum and Bass,” “Trip Hop,” or “Trance,” for example. Each of these one or more categories comprise one or more real content names.

The “Movies” real content name may include “Spiderman,” for example. The version based content comprises digital media. In alternate embodiments, the version based content comprises JPEG, MPEG, MP3, or FLASH files. In alternate embodiments, the version based content is organized on the syndicator in a flat format structure.

In yet another embodiment, the version based content distribution system further comprises a proxy personal computer. The proxy personal computer is configured to receive the content from and communicate with the syndicator. Further, the proxy personal computer is configured to transmit the content received from the syndicator to the subscriber.

In an alternate embodiment, a content distribution system comprising a distribution server, a hand held device, and an electronic proxy device is disclosed. Specifically, the distribution server is configured to transmit content—the content comprising a server version. The hand held device is configured to receive the content and comprises a device version. The electronic proxy device comprises a version identifier and is configured to receive the device version from the hand held device and the server version from the distribution server. Further, the electronic proxy device is configured to compare the server version with the device version. If the server version is greater than the device version, the electronic proxy device downloads the content from the distribution server and transmits the content to the hand held device. As detailed above, the content comprises digital media, including, but not limited to, JPEG, MPEG, MP3, or FLASH files.

In an alternate embodiment, an entertainment system for providing content to one or more users is disclosed. The entertainment system preferably comprises a plurality of distribution control devices, a rerouting device, and a subscription device. The control devices are configured to store and transmit version based content. The rerouting device is configured to receive the version based content transmitted from the distribution control devices. In addition, the rerouting device is configured to add a version stamp to the version based content and to reroute the version based content.

The subscription device of the entertainment system is configured to receive the rerouted version based content containing the version stamp from the rerouting device.

The subscription device is further configured to allow a user to select, control, and play the version based content.

The version stamp preferably comprises a version number. As explained above, the content includes, but is not limited to, digital media, such as JPEG, MPEG, MP3, or FLASH files, for example.

A content subscription system is also disclosed. The content subscription system comprises a server, a subscriber, a server content identification circuit, a subscriber content identification circuit, and a content control circuit.

The server content identification circuit is configured to transmit a first signal representative of a version identifier. This version identifier corresponds to a first content (which includes, but is not limited to, digital media, JPEG, MPEG, MP3, or FLASH files) stored within the server. The version identifier comprises a version number or a date and time stamp, depending on the embodiment.

The subscriber content identification circuit is configured to receive the version identifier and the first content stored within the server. In addition, the subscriber content identification circuit is configured to generate a second signal representative of a subscriber version identifier. This subscriber version identifier corresponds to a second content stored within the subscriber. The content control circuit is configured to transmit the first content to the subscriber content identification circuit in response to the second signal.

In additional embodiments, the content subscription system disclosed above further comprises an output signal generation circuit. The output signal generation circuit is electronically coupled to the server and the subscriber. Further, the output signal generation circuit is configured to detect a difference between the version identifier and the subscriber version identifier and generate a control output signal. Specifically, the control output signal instructs the content control circuit to transmit the first content to the subscriber content identification circuit if the version identifier is greater than the subscriber version identifier.

In addition to the devices and systems disclosed above, a method of distributing content is disclosed. The first step of the method comprises defining a current version number for content stored within a syndicator. Next, the current version number is increased when the content stored within the syndicator is updated. Then a subscriber version number is defined for content stored within a subscriber. Following this step, the current version number is transmitted from the syndicator to the subscriber. After the transmission is complete, a synchronization verification is performed. This synchronization verification entails the subscriber version number being compared to the current version number.

Afterwards, the content stored within the syndicator is downloaded to the subscriber if the subscriber version number is found to be less than the current version number during the synchronization verification. Finally, the subscriber version number is increased to correspond to the current version number following downloading of the content stored within the syndicator.

As described above, the syndicator comprises a server and the subscriber comprises a personal digital assistant, a hand held electronic device, or a personal computer. Further, the version number comprises a date and time stamp. In addition, the content stored within the syndicator comprises digital media, and includes, but is not limited to, JPEG, MPEG, MP3, or FLASH files.

### BRIEF DESCRIPTION OF THE DRAWINGS

FIG. 1 illustrates a simplified representation of version based content, in accordance with the instant invention.

FIG. 2A illustrates a simplified block diagram of the internal components of a syndicator of a content distribution system, in accordance with the instant invention.

FIG. 2B illustrates a simplified representation of a content distribution system with the version based content shown in FIG. 1, the syndicator shown in FIG. 2A, and a subscriber, in accordance with the instant invention.

FIG. 3A illustrates a simplified block diagram of the internal components of a proxy personal computer of a content distribution system, in accordance with the instant invention.

FIG. 3B illustrates a simplified representation of a content distribution system with the syndicator shown in FIG. 2A, the proxy personal computer shown in FIG. 3A, and a subscriber in accordance with the instant invention.

FIG. 4 illustrates a simplified representation of an entertainment system with one or more distribution control devices, a rerouting device, and a subscription device in accordance with the instant invention.

FIG. 5 illustrates a flow chart detailing the method to distribute content, in accordance with the instant invention.

### DETAILED DESCRIPTION OF THE INVENTION

A version based content distribution system is disclosed. This content distribution system is designed for content distribution from a syndicator to a subscriber. The system comprises content, a syndicator, subscriber content, and a subscriber. The content comprises a version number. Similarly, the subscriber content comprises a subscriber content version number.

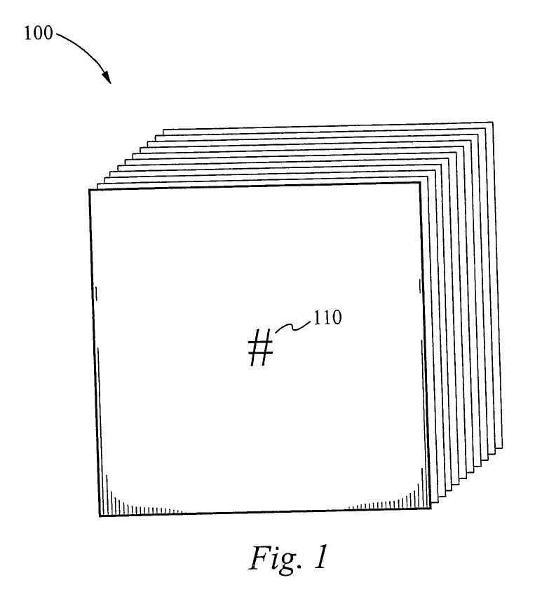

FIG. 1 illustrates a simplified representation of version based content, in accordance with the instant invention. Specifically, version based content 100 is shown. The version based content 100 preferably comprises digital media. In alternate embodiments, the content comprises JPEG, MPEG, MP3, or FLASH files. The preferred version based content comprises a version number 110.

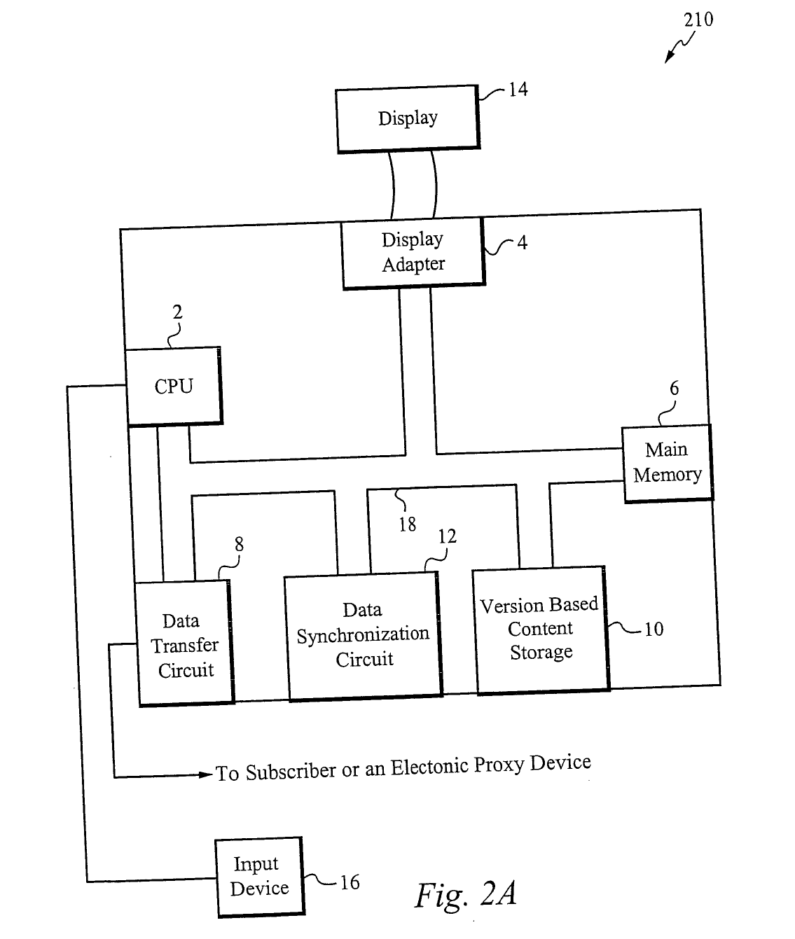

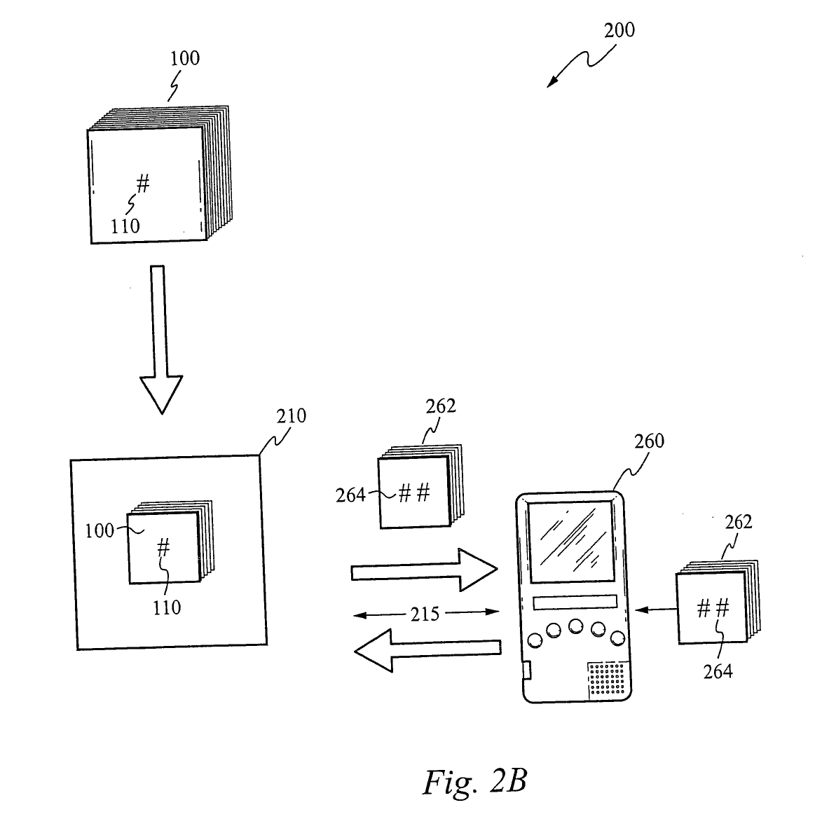

FIG. 2A illustrates a simplified block diagram of the internal components of a syndicator of a content distribution system. Specifically, the syndicator 210 shown in FIG. 2A is exemplary and the syndicator of a content distribution can comprise any appropriately configured computer system or wireless internet access device. The exemplary syndicator 210 includes a CPU 2, a main memory 6, a display adapter 4, a version based content storage device 10, a data transfer circuit 8, and a data synchronization circuit 12, all coupled together by a conventional bidirectional system bus 18. The data transfer circuit 8 is configured to communicate with and transfer version based content (not shown) stored within the version based content storage device 10 to a subscriber (not shown) or to an electronic proxy device (not shown). The version based content storage device 10 is preferably a mass storage device and may include both fixed and removable media using any one or more of magnetic, optical or magneto-optical storage technology or any other available mass storage technology. The system bus 18 contains an address bus for addressing any portion of the memory 6 and 10. The system bus 18 also includes a data bus for transferring data between and among the CPU 2, the main memory 6, the display adapter 4, the version based content storage device 10, the data synchronization circuit 12, and the data transfer circuit 8.

In alternate embodiments, the syndicator 210 is also coupled to a number of peripheral input and output devices including the input device 16 and the associated display 14. The input device 16 may be any appropriate input device including keyboard, mouse, touch screen or stylus.

The display adapter 4 interfaces between the components within the syndicator 210 and the display 4. The display adapter 4 converts data received from the components within the syndicator 210 into signals which are used by the display 14 to generate images for display.

FIG. 2B illustrates a simplified representation of a content distribution system 200. Specifically, the content distribution system 200 comprises the version based content 100 shown in FIG. 1, the syndicator 210 shown in FIG. 2A, and a subscriber 260.

The syndicator 210 is configured to distribute the content 100 and the subscriber 260 is configured to store the content 100. The content stored within the subscriber is the subscriber content 262 and preferably comprises a subscriber content version number 264. Preferably, the syndicator 210 comprises a server. In addition, the preferred content distribution system utilizes the syndicator 210 as the controller, distributor, and synchronizer for all the content 100 and any subscriber 260. The content 100 is preferably distributed by an internet protocol method. In addition, the subscriber 260 is configured to compare the version number 110 with the subscriber content version number 264. Further, the subscriber 260 is configured to receive the content 100 from the syndicator 210 if the version number 110 is larger than the subscriber content version number 264.

The preferred subscriber 260 is further configured to display the subscriber content and preferably comprises a personal digital assistant. In alternate embodiments, the subscriber 260 comprises a hand held electronic device. In yet other embodiments, the subscriber 260 comprises a personal computer.

In alternate embodiments, the syndicator 210 disclosed above further comprises a data synchronization scheme (not shown). The data synchronization scheme (not shown) is configured to compare the version number 110 with the subscriber content version number 264 and to transfer the content 100 to the subscriber 260 based on a predetermined transfer method. In the various embodiments, the predetermined transfer methods include, but are not limited to application driven, isochronous, or syndicator to subscriber one-way synchronization data transfer methods.

In the preferred version based content distribution system 200, the subscriber 260 is configured to communicate with the syndicator 210 via an internet protocol method 215. Further, the subscriber 260 is configured to receive content 100 based on preferences set by a user of the subscriber. The syndicator 210 is further configured to store the content 100 in alternate embodiments.

The content 100 is preferably organized on the syndicator 210 in a tree like structure (not shown). Specifically, the tree like structure comprises one or more channels. For example, the channels may be named “Music,” “Movies,” or “Games.” Each of the one or more channels comprise one or more subchannels. Examples of the “Music” subchannels include subchannels such as “Blues,” “Electronica,” “Reggae.” Further, the “Movies” subchannels may include “Action,” “Mystery,” or “Musicals” subchannels. The “Games” subchannels may include “Role Playing,” “Simulators,” or “Action,” for example. Further, each of the one or more subchannels comprise one or more categories. The “Electronica” categories include “Drum and Bass,” “Trip Hop,” or “Trance,” for example. Each of these one or more categories comprise one or more real content names. The “Movies” real content name may include “Spiderman,” for example.

In alternate embodiments, the content 100 is organized on the syndicator 210 in a flat format structure (not shown).

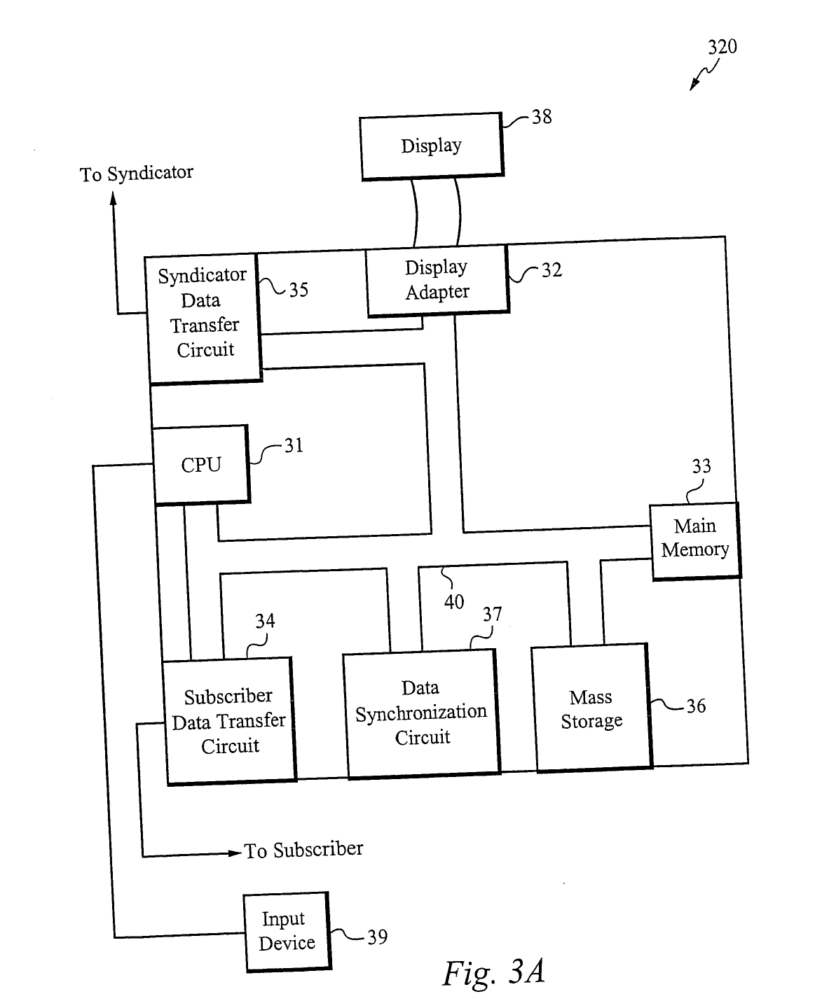

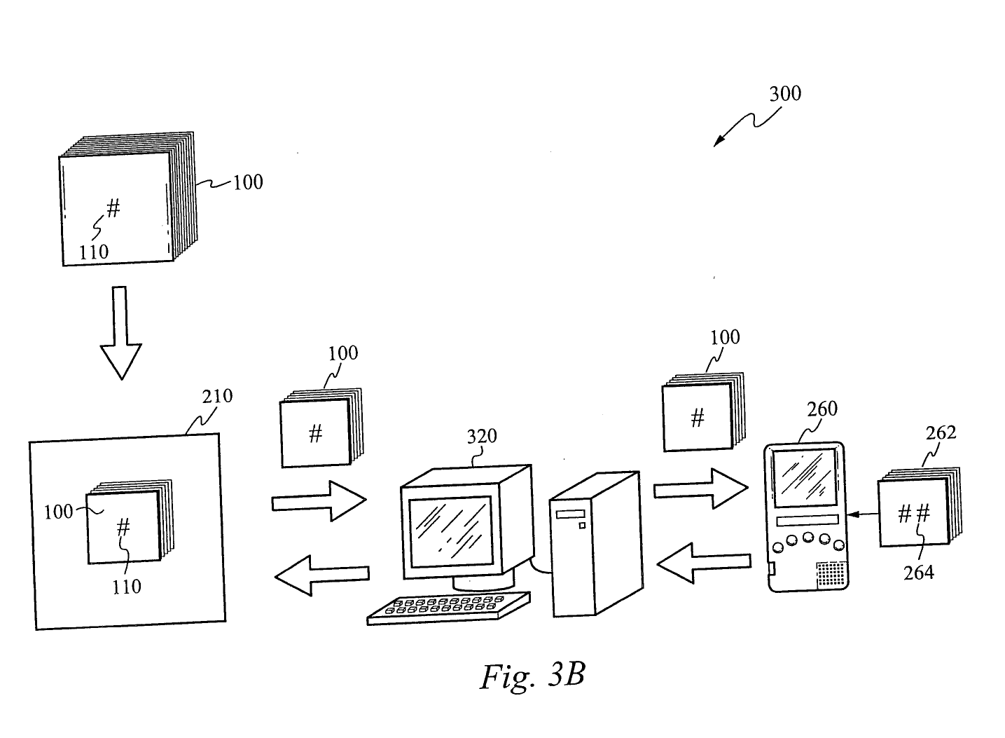

FIG. 3A illustrates a simplified block diagram of the internal components of a proxy personal computer of a content distribution system. Specifically, the proxy personal computer 320 shown in FIG. 3A is exemplary and the proxy personal computer of a content distribution can comprise any appropriately configured computer system or wireless internet access device. The exemplary proxy personal computer 320 includes a CPU 31, a main memory 33, a display adapter 32, a mass storage device 36, a subscriber data transfer circuit 34, a syndicator data transfer circuit 35, and a data synchronization circuit 37, all coupled together by a conventional bidirectional system bus 40. The subscriber data transfer circuit 34 is configured to communicate with and transfer version based content (not shown) stored within the mass storage device 36 to a subscriber (not shown). The syndicator data transfer circuit 35 is configured to communicate with and receive version based content (not shown) stored within the syndicator 210 (not shown). The mass storage device 36 may include both fixed and removable media using any one or more of magnetic, optical or magneto-optical storage technology or any other available mass storage technology. The system bus 40 contains an address bus for addressing any portion of the memory 33 and 36. The system bus 40 also includes a data bus for transferring data between and among the CPU 31, the main memory 33, the display adapter 32, the mass storage device 36, the data synchronization circuit 37, the subscriber data transfer circuit 34, and the syndicator data transfer circuit 35.

In alternate embodiments, the proxy personal computer 320 is also coupled to a number of peripheral input and output devices including the input device 39 and the associated display 38. The input device 39 may be any appropriate input device including keyboard, mouse, touch screen or stylus.

The display adapter 32 interfaces between the components within the proxy personal computer 320 and the display 38. The display adapter 32 converts data received from the components within the proxy personal computer 320 into signals which are used by the display 38 to generate images for display.

FIG. 3B illustrates another embodiment of a content distribution system. Specifically, the content distribution system 300 comprises the syndicator 210 shown in FIG. 2A, the proxy personal computer 320 shown in FIG. 3A, and a subscriber 260 in accordance with the instant invention. The proxy personal computer 320 is configured to receive the content 100 from and communicate with the syndicator 210. Further, the proxy personal computer 310 is configured to transmit the content 100 received from the syndicator 210 to the subscriber 260.

Specifically, the proxy personal computer 320 communicates with the subscriber 260 and determines the version number of the content contained within the subscriber 260. Further, the syndicator 210 communicates with the proxy personal computer 320. The syndicator 210 determines whether the version number of the content contained within the proxy personal computer 320 or the subscriber 260 is greater or less than the content contained within the syndicator by comparing the version numbers of the two contents. If the version number of the syndicator content is greater, than the syndicator 210 distributes the content contained within the syndicator to the proxy personal computer 320. Then, the proxy personal computer 320 communicates with the subscriber 260 and distributes the content received from the syndicator 210 to the subscriber 260.

In alternate embodiments, a content distribution system comprises a distribution server, a hand held device, and an electronic proxy device. Specifically, the distribution server is configured to transmit content comprising a server version. The hand held device is configured to receive the content and comprises a device version. The electronic proxy device comprises a version identifier (not shown) and is configured to receive the device version from the hand held device and the server version from the distribution server. Further, the electronic proxy device is configured to compare the server version with the device version. If the server version is greater than the device version, the electronic proxy device downloads the content from the distribution server and transmits the content to the hand held device. As detailed above, the content preferably comprises digital media. Other embodiments of the content include, but are not limited to JPEG, MPEG, MP3, or FLASH files.

In yet another embodiment, a content subscription system (not shown) comprises a server, a subscriber, a server content identification circuit, a subscriber content identification circuit, and a content control circuit.

The server content identification circuit is configured to transmit a first signal representative of a version identifier. This version identifier corresponds to a first content (including, but is not limited to, digital media, JPEG, MPEG, MP3, or FLASH files) stored within the server. The version identifier comprises a version number or a date and time stamp, depending on the embodiment.

The subscriber content identification circuit is configured to receive the version identifier and the first content stored within the server. In addition, the subscriber content identification circuit is configured to generate a second signal representative of a subscriber version identifier. This subscriber version identifier corresponds to a second content stored within the subscriber. The content control circuit is configured to transmit the first content to the subscriber content identification circuit in response to the second signal. An output signal generation circuit is added in alternate embodiments. The output signal generation circuit is electronically coupled to the server and the subscriber. Further, the output signal generation circuit is configured to detect a difference between the version identifier and the subscriber version identifier and generate a control output signal. Specifically, the control output signal instructs the content control circuit to transmit the first content to the subscriber content identification circuit if the version identifier is greater than the subscriber version identifier.

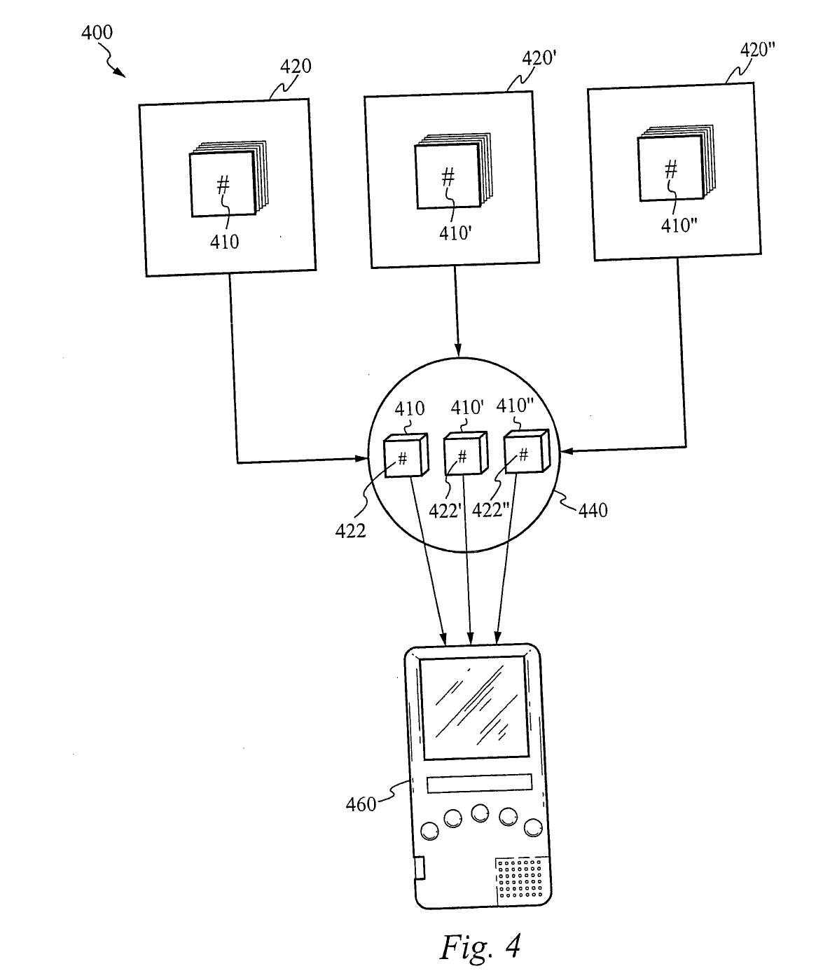

In yet another alternate embodiment, an entertainment system for providing content from a plurality of distribution control devices is disclosed. FIG. 4 illustrates a simplified representation of the entertainment system 400. The entertainment system 400 comprises a plurality of distribution control devices 420, 420′, and 420″, a rerouting device 440, and a subscription device 460. The plurality of distribution control devices 420, 420′, and 420″ are configured to store and transmit version based content 410, 410′, and 410″. The rerouting device 440 is configured to receive the version based content 410, 410′, and 410″ transmitted from the plurality of distribution control devices 420, 420′, and 420″. In addition, the rerouting device 440 is configured to add a version stamp 422, 422′, and 422″ to the version based content 410, 410′, and 410″ and to reroute the version based content 410.

The subscription device 460 is configured to receive the rerouted version based content 410, 410′, and 410″ with the version stamp 422, 422′, and 422″ from the rerouting device 420. The subscription device 460 is further configured to allow a user (not shown) to select, control, and play the version based content 410, 410′, and 410″. It should be understood that the version based content 410, 410′, and 410″ and the associated plurality of distribution control devices 420, 420′, and 420″ and version stamp 422, 422′, and 422″ are merely representations of a plurality.

The version stamp 422, 422′, and 422″ preferably comprises a version number (not shown). As explained above, the content 410, 410′, and 410″ includes, but is not limited to digital media, JPEG, MPEG, MP3, or FLASH files.

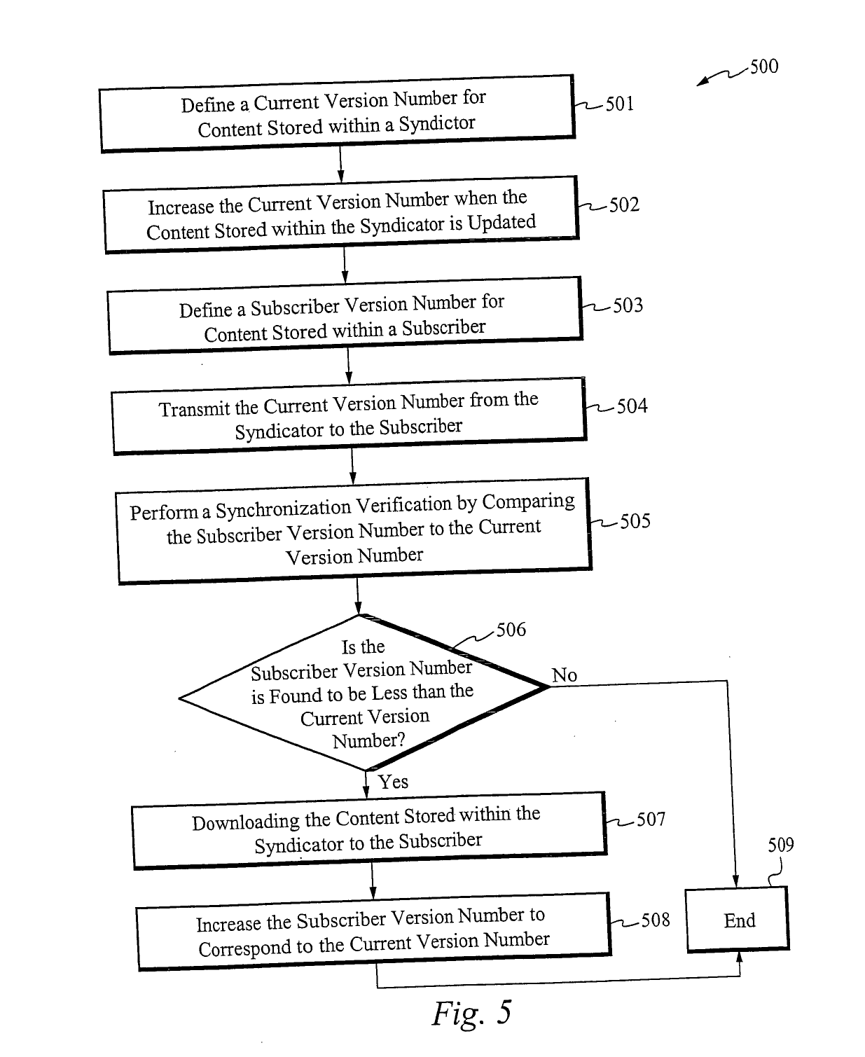

In addition to the devices and systems disclosed above, a method of distributing content is disclosed. FIG. 5 illustrates a flow chart 500 detailing the method to distribute content, in accordance with the instant invention.

At the step 501 a current version number for content stored within a syndicator is defined. At the step 502, the current version number is increased when the content stored within the syndicator is updated. Following the step 502, at the step 503, a subscriber version number is defined for content stored within a subscriber. At the step 504, the current version number is then transmitted from the syndicator to the subscriber. After the transmission is complete, a synchronization verification is preformed at the step 505.

This synchronization verification entails the subscriber version number being compared to the current version number. At the step 506, it is determined if the subscriber version number is less than the current version number.

If it is determined at the step 506 that the subscriber version number is less than the current version number, then the content stored within the syndicator is downloaded to the subscriber at the step 507. The subscriber number is then increased to correspond to the current version number at the step 508. The synchronization and distribution then ends at the step 509. If it is determined at the step 506 that the subscriber version number is not less than the current version number, then the content distribution does not occur and the synchronization and distribution ends at the step 509.

As described above preferably, the syndicator comprises a server and the subscriber comprises a personal digital assistant, a hand held electronic device, or a personal computer. Further, the version number comprises a date and time stamp. In addition, the content stored within the syndicator comprises digital media, and includes, but is not limited to, JPEG, MPEG, MP3, or FLASH files.

In operation, a subscriber communicates with a server to synchronize with and obtain version based content from the syndicator. This communication, content distribution, and synchronization is preferably done via an internet protocol method. For example, the version based content is distributed by a syndicator serving as a web server to subscribers that include PCs and PDAs. Regardless of the means for communication, content distribution, and synchronization, the syndicator serves as a controller for all of the subscribers and version based content. Further, the syndicator preferably distributes the version based content based on a subscriber user's preference. The subscriber is passive and receives current version based content distributed by the syndicator. Thus, the synchronization and distribution of the version based content is preferably a one-way synchronization from the syndicator to the subscriber.

Once the subscriber communicates with the server and requests to synchronize with and obtain version based content from the syndicator, the syndicator determines whether the content stored on the syndicator is more current than that stored within the subscriber. This is preferably done by comparing a version number of the content stored within the syndicator with a version number of the content stored within the subscriber. If the version number of the content stored within the syndicator is greater than that of the version number of the subscriber content, the synchronization and version based content distribution between the syndicator and the subscriber is commenced by the syndicator. Due to the fact that the version based content is preferably stored in a tree like structure, as described above, and with a version number, the data distribution and synchronization occurs in a more efficient and effective manner with more flexibility in content organization, as well as less process overhead for both syndicator and subscriber sides. Also, both the syndicator and the subscriber only need to store a version number for version based content synchronization and distribution.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

Specifically, it will be apparent to one of ordinary skill in the art that the device of the present invention could be implemented in several different ways and the embodiments disclosed above are only exemplary of the preferred embodiment and the alternate embodiments of the invention and is in no way a limitation.

1. A version based content distribution system comprising:
a. content comprising a version number;
b. a syndicator, wherein the syndicator is configured to distribute the content;
c. subscriber content comprising a subscriber content version number; and
d. a subscriber configured to store the subscriber content, to compare the version number with the subscriber content version number, and to receive the content from the syndicator if the version number is larger than the subscriber content version number.

2. The version based content distribution system of claim 1, wherein the syndicator comprises a server.

3. The version based content distribution system of claim 1, wherein the subscriber is further configured to display the subscriber content.

4. The version based content distribution system of claim 1, wherein the subscriber comprises a personal digital assistant.

5. The version based content distribution system of claim 1, wherein the subscriber comprises a hand held electronic device.

6. The version based content distribution system of claim 1, wherein the subscriber comprises a personal computer.

7. The version based content distribution system of claim 1, wherein the syndicator further comprises a data synchronization scheme configured to compare the version number with the subscriber content version number and to transfer the content to the subscriber based on a predetermined transfer method.

8. The version based content distribution system of claim 7, wherein the predetermined transfer method comprises an application driven data transfer method.

9. The version based content distribution system of claim 7, wherein the predetermined transfer method comprises an isochronous data transfer method.

10. The version based content distribution system of claim 9, wherein the isochronous data transfer method comprises a syndicator to subscriber one-way synchronization.

11. The version based content distribution system of claim 1, wherein the subscriber is configured to communicate with the syndicator via an internet protocol method.

12. The version based content distribution system of claim 1, wherein the subscriber is further configured to receive content based on preferences set by a user of the subscriber.

13. The version based content distribution system of claim 1, wherein the syndicator is further configured to store the content.

14. The version based content distribution system of claim 1, wherein the content is organized on the syndicator in a flat format structure.

15. The version based content distribution system of claim 1, wherein the content is organized on the syndicator in a tree like structure.

16. The version based content distribution system of claim 15, wherein the tree like structure comprises one or more channels, wherein each of the one or more channels comprise one or more subchannels, and further wherein each of the one or more subchannels comprise one or more categories.

17. The version based content distribution system of claim 16, wherein each of the one or more categories comprise one or more real content names.

18. The version based content distribution system of claim 1, wherein the content comprises digital media.

19. The version based content distribution system of claim 1, wherein the content comprises JPEG, MPEG, MP3, or FLASH files.

20. The version based content distribution system of claim 1, wherein the content distribution system further comprises a proxy personal computer configured to receive the content from and communicate with the syndicator and to transmit the content received from the syndicator to the subscriber.

21. A content distribution system comprising:
a. a distribution server configured to transmit content, wherein the content comprises a server version;
b. a hand held device comprising a device version, wherein the hand held device is configured to receive the content; and
c. an electronic proxy device comprising a version identifier, wherein the electronic proxy device is configured to receive the device version from the hand held device and the server version from the distribution server, and is further configured to compare the server version with the device version, and if the server version is greater than the device version, to download the content from the distribution server and to transmit the content to the hand held device.

22. The content distribution system of claim 21, wherein the content comprises digital media.

23. The content distribution system of claim 21, wherein the content comprises JPEG, MPEG, MP3, or FLASH files.

24. An entertainment system for providing content to one or more users, comprising:
a. one or more distribution control devices configured to store and transmit version based content;
b. a rerouting device configured to receive the version based content transmitted from the one or more distribution control devices, to add a version stamp to the version based content, and to reroute the version based content; and
c. a subscription device configured to receive the rerouted version based content with the version stamp from the rerouting device.

25. The content distribution system of claim 24, wherein the version stamp comprises a version number.

26. The entertainment system of claim 24, wherein the subscription device is further configured to allow a user to select, control, and play the version based content.

27. The entertainment system of claim 24, wherein the version based content comprises digital media.

28. The entertainment system of claim 24, wherein the version based content comprises JPEG, MPEG, MP3, or FLASH files.

29. A content subscription system comprising:
a. a server;
b. a subscriber;
c. a server content identification circuit configured to transmit a first signal representative of a version identifier, wherein the version identifier corresponds to a first content stored within the server;
d. a subscriber content identification circuit configured to receive the version identifier and the first content stored within the server, wherein the subscriber content identification circuit is further configured to generate a second signal representative of a subscriber version identifier, wherein the subscriber version identifier corresponds to a second content stored within the subscriber; and
e. a content control circuit configured to transmit the first content to the subscriber content identification circuit in response to the second signal.

30. The content subscription system of claim 29, wherein the subscriber version identifier comprises a version number.

31. The content subscription system of claim 29, wherein the subscriber version identifier comprises a date and time stamp.

32. The content subscription system of claim 29, wherein the first content comprises digital media.

33. The content subscription system of claim 29, wherein the first content comprises JPEG, MPEG, MP3, or FLASH files.

34. The content subscription system of claim 24, wherein the system further comprises an output signal generation circuit electronically coupled to the server and the subscriber and configured to detect a difference between the version identifier and the subscriber version identifier and generate a control output signal that instructs the content control circuit to transmit the first content to the subscriber content identification circuit if the version identifier is greater than the subscriber version identifier.

35. A method of distributing content comprising:
a. defining a version number for content stored within a syndicator;
b. increasing the version number when the content stored within the syndicator is updated;
c. defining a subscriber version number for content stored within a subscriber;
d. transmitting the version number from the syndicator to the subscriber;
e. performing a synchronization verification wherein the subscriber version number is compared to the version number;
f. downloading the content stored within the syndicator to the subscriber if the subscriber version number is found to be less than the version number during the synchronization verification; and
g. increasing the subscriber version number to correspond to the version number following downloading of the content stored within the syndicator.

36. The method of distributing content of claim 35, wherein the syndicator comprises a server.

37. The method of distributing content of claim 35, wherein the subscriber comprises a personal digital assistant.

38. The method of distributing content of claim 35, wherein the subscriber comprises a hand held electronic device.

39. The method of distributing content of claim 35, wherein the subscriber comprises a personal computer.

40. The method of distributing content of claim 35, wherein the version number comprises a date and time stamp.

41. The method of distributing content of claim 35, wherein the version identifier comprises a version number.

42. The method of distributing content of claim 35, wherein the content stored within the syndicator comprises digital media.

43. The method of distributing content of claim 35, wherein the content stored within the syndicator comprises JPEG, MPEG, MP3, or FLASH files.
